(19) United States
(12) Patent Application Publication
(10) Pub. No.: US 2019/0215596 A1
(43) Pub. Date: Jul. 11, 2019

(54) SMART HEADPHONES

(71) Applicant: Chatilla Van Grinsven, Rosmalen (NL)

(72) Inventor: Chatilla Van Grinsven, Rosmalen (NL)

(21) Appl. No.: 16/233,029

(22) Filed: Dec. 26, 2018

Related U.S. Application Data
(60) Provisional application No. 62/609,710, filed on Dec. 22, 2017.

(51) Int. Cl. H04R 1/10; G06F 3/16; H04M 1/725; H04R 5/033

(52) U.S. Cl. CPC H04R 1/1041; G06F 3/165; H04R 2420/07; H04R 5/033; H04M 1/72558

(57) ABSTRACT

A communication and listening device; the communication and listening device includes a headset, a controller, a display-panel, a speaker and an access means. The communication and listening device is able to make phone calls and to assist the user in any online audio or visual search without needing an additional device such as a cell phone.

### CROSS REFERENCE TO RELATED APPLICATION

The present application is related to and claims priority to U.S. Provisional Patent Application No. 62/609,710 filed Dec. 22, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of audio devices and more specifically relates to headphones.

### 2. DESCRIPTION OF RELATED ART

Many individuals enjoy listening to music. Listening to music with headphones typically requires a smartphone or tablet connection. Users must navigate the electronic device, choose songs, etc. in order to hear audio through the headphones. People may be looking for a hands-free, all-in-one method of making phone calls, listening to music, and more. It can be time-consuming to use search engines on a cellular phone or tablet screen. A suitable solution is desired.

U.S. Pub. No. 2008/0031475 to Steven Goldstein relates to a personal audio assistant device and method. The described personal audio assistant device and method includes an earpiece comprising: an ambient microphone; an ear canal microphone; an ear canal receiver; a sealing section; a logic circuit; a communication module; a memory storage unit, and a user interaction element, where the user interaction element is configured to send a play command to the logic circuit when activated by a user where the logic circuit reads registration parameters stored on the memory storage unit and sends audio content to the ear canal receiver according to the registration parameters.

### BRIEF SUMMARY OF THE INVENTION

In view of the foregoing disadvantages inherent in the known audio device art, the present disclosure provides novel smart headphones. The general purpose of the present disclosure, which will be described subsequently in greater detail, is to provide smart headphones configured to function as a smartphone, negating the need to use a separate smartphone.

A communication and listening device is disclosed herein. The communication and listening device includes a headset which may include at least one ear-piece and a fastening means for fastening the at least one ear-piece about an ear of a user. The at least one ear-piece may include a first-side and a second-side. A controller may be located within the headset and may include a microprocessor and a memory. The memory may store at least one audio file. A display-panel may be located on the second-side of the at least one ear-piece and communicably coupled to the controller. Further, the display-panel may have a user-interface. In addition, a speaker may be located on the first-side of the at least one ear-piece and configured to play the at least one audio file. Furthermore, an access means may be located within the headset, the access means may be configured to allow communication with at least one mobile-network.

A method of using the communication and listening device is also disclosed herein. The method of using the communication and listening device may comprise the steps of: providing the communication and listening device as above; fastening the at least one ear-piece about the ear of the user via the fastening means; and listening to the at least one audio file.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, smart headphones, constructed and operative according to the teachings of the present disclosure.

FIG. 1 is a side perspective view of the communication and listening device during an ‘in-use’ condition, according to an embodiment of the disclosure.

FIG. 2 is a side perspective view of the communication and listening device of FIG. 1, according to an embodiment of the present disclosure.

FIG. 3 is a front perspective view of the communication and listening device of FIG. 1, according to an embodiment of the present disclosure.

FIG. 4 is a side perspective view of the communication and listening device of FIG. 1, according to an embodiment of the present disclosure.

FIG. 5 is a side perspective view of the communication and listening device of FIG. 1, according to an embodiment of the present disclosure.

FIG. 6 is a flow diagram illustrating a method of use for the communication and listening device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to audio devices and more particularly to smart headphones as used to improve the efficient and effective use of headphones.

Generally, disclosed are smart headphones. The smart headphones may include built-in digital intelligent assistant and touchscreen. A user may be able to speak voice commands into the smart headphones in order to operate the headphones or navigate by touchscreen on the side of the headphones. The smart headphones may comprise the (general) appearance of conventional wireless headphones and include a SIM card slot to allow for use of a mobile network with the headphones. The headphones may negate the need for use of a separate smartphone, as the headphones may be configured to send and receive phone calls and texts, and also access internet via data provided by the mobile network.

The headphones may be useful for playing music, audio online search, phone calls and audio navigation as well as any other functions that a smart phone has such as access to an app store to download apps such as games and eBooks. Further, the headphones may include a memory card slot for allowing a user to store more data on the headphones. The user may command the headphones by pressing a side button located on the headphones and a user may ask for a particular song; for audio navigation to a certain location; audio online search engine; or placing a phone call. In an alternative embodiment, the user may command the headphones. To begin the command, the user may first ask “LUNA”. The headphones may also be connected to Bluetooth in case the operator does want to connect to a device or mobile phone. The Bluetooth option may also provide a way to upload audio onto the headphones. Further to this, the smart headphones may incorporate a touch screen that has a click-out system so the user may hold the touchscreen separately in the hand while wearing the headset. The smart headphones may be available in various styles, including ear buds and ear pieces, in order to accommodate all user needs and preferences. Exact size, measurement, construction, and design specifications may vary upon manufacturing. In some embodiments, the headphones may be without the touchscreen on the side of the headphone with only access to audio commands.

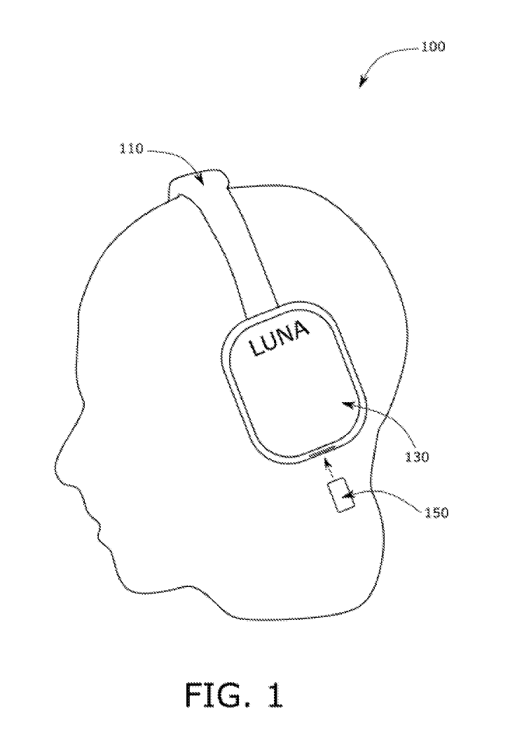

Referring now more specifically to the drawings by numerals of reference, there is shown in FIGS. 1-5, various views of a communication and listening device 100.

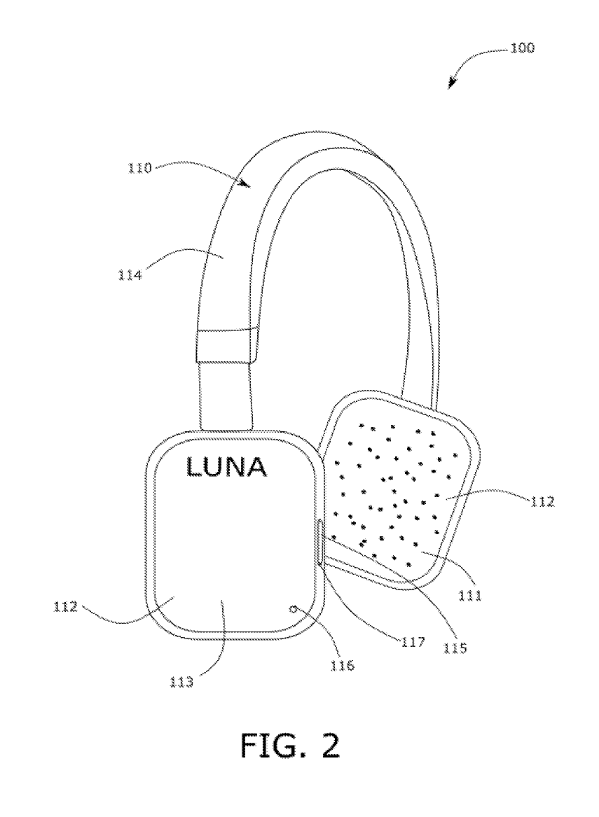

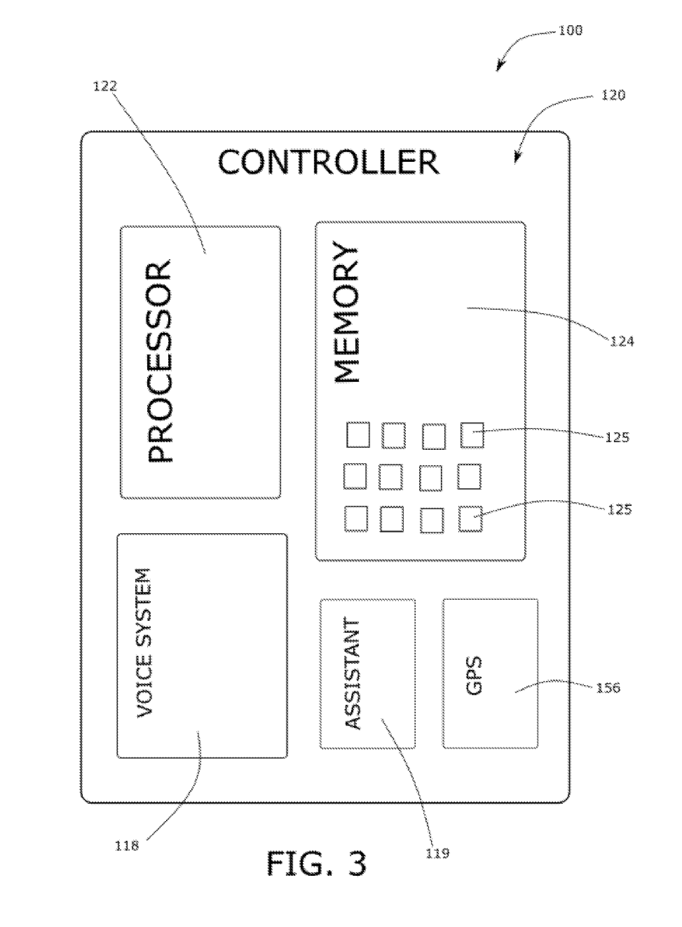

FIG. 1 shows a communication and listening device 100 during an ‘in-use’ condition 150, according to an embodiment of the present disclosure. As illustrated, the communication and listening device 100 may include a headset 110, a controller 120 (FIG. 3), a display-panel 130, a speaker 140 (FIG. 2), and an access means 150.

FIG. 2 shows a side perspective view of the communication and listening device 100 of FIG. 1, according to an embodiment of the present disclosure. The headset 110 may include at least one ear-piece 112 and a fastening means 114 for fastening the at least one ear-piece 112 about an ear of a user. As shown in this figure, the headset 110 may be a set of headphones. In this embodiment, the headphones may include two ear-piece 112s. Further, the fastening means 114 may be a headband that is worn around a head of the user. It should be appreciated that other headset 110s may be used such as earphones having two ear-pieces 112 or a BLUETOOTH headset 110 having one ear-piece 112.

The at least one ear-piece 112 may include a first-side 111 and a second-side 113. The speaker 140 may be located on the first-side 111 of the at least one ear-piece 112 and configured to play at least one audio file 125 (FIG. 3) into the ear of the user. The communication and listening device 100 may further include a microphone 116 located on the headset 110. The microphone 116 may be located near to a mouth of the user such that the user is able to speak into the microphone 116 with ease.

In addition to this, the communication and listening device 100 may include an external storage device 115. Further, the headset 110 may include a storage device slot 117 configured to receive and interface with the external storage device 115. This may allow the user to store a plurality of audio files thereon. Examples of external storage devices contemplated are memory cards, memory sticks, USB drives, etc.

FIG. 3 shows a front perspective view of the communication and listening device 100 of FIG. 1, according to an embodiment of the present disclosure. The controller 120 may be located within the headset 110. The controller 120 may include a microprocessor 122 and a memory 124 which may store the at least one audio file 125. The memory 124 may include a predetermined amount of storage space.

Preferably, the communication and listening device 100 may include a voice command system 118 configured to transform a voice communication received from the microphone 116, and convert the voice communication into an electrical signal. The voice command system 118 may be configured to recognize and take commands off of a specific user. The voice command system 118 may analyze the specific users' voice and fine tune recognition of the specific users' speech to create an accurate profile of the specific user's voice, such that the voice command system 118 is fully able to recognize and understand commands.

In addition to this, the communication and listening device 100 may include a virtual assistant application 119 to interface with the voice command system 118. For example, the user may use their voice communication to utilize the voice command system 118, and the virtual assistant application 119 may recognize and understand the voice communication, and answer back via a synthesized voice. The virtual assistant application 119 may receive the voice communication, determine a response to the voice communication by selecting from a plurality of preprogrammed words and phrases, and transmit a chosen word or phrase via the speaker 140 (FIG. 2).

Further, the communication and listening device 100 may include a global positioning means 156. The global positioning means 156 may allow the user to use maps.

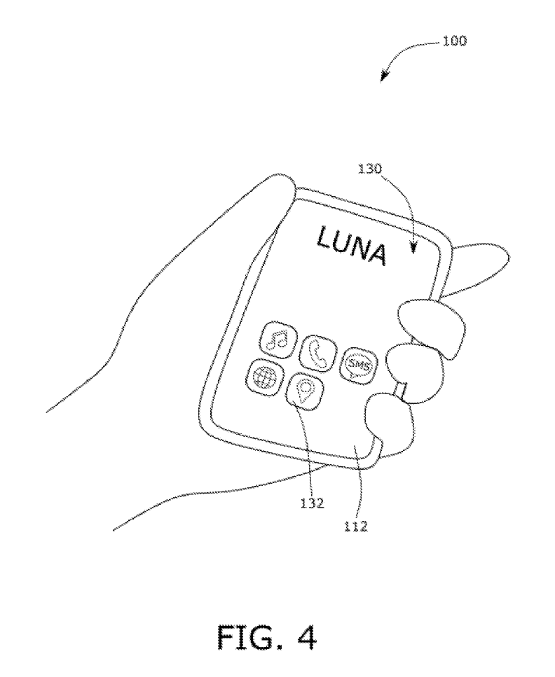

FIG. 4 shows a side perspective view of the communication and listening device 100 of FIG. 1, according to an embodiment of the present disclosure. The display-panel 130 may be located on the second-side 113 of the at least one ear-piece 112 and communicably coupled to the controller 120 (FIG. 3). The display-panel 130 may have a user-interface 132. Preferably, the user-interface 132 may be a touchscreen. Further, in one embodiment, the display-panel 130 may be removable. This may allow the user to remove the display-panel 130 from the headset 110 (FIG. 2) and utilize the display-panel 130 as one would use a smartphone, whilst the headset 110 (FIG. 2) remains fastened about the ear of the user.

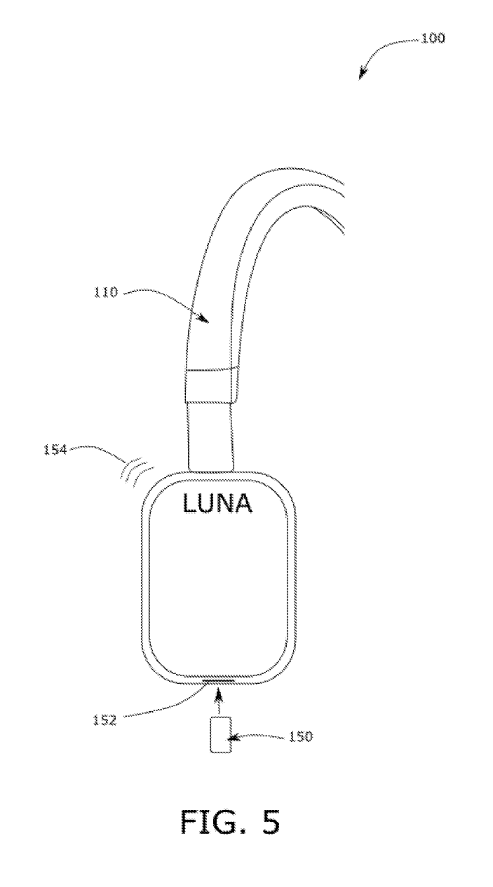

FIG. 5 shows a side perspective view of the communication and listening device 100 of FIG. 1, according to an embodiment of the present disclosure. The access means 150 may be located within the headset 110 and configured to allow communication with at least one mobile-network. In one embodiment, the access means 150 may be a smart card. Preferably, the smart card may be a subscriber identification module (SIM) card. In this embodiment, the headset 110 may include a smart card slot 152 configured to receive and interface with the identification module (SIM) card. The smart card slot 152 may include circuitry for interfacing with the SIM card. The mobile network may be provided by a mobile carrier. The mobile network may include a core circuit switched network configured to facilitate calls and texts. Further, the mobile network may include a packet switched network configured to facilitate mobile data. In this embodiment, the headset 110 may include GSM technology. However, it is contemplated that other technologies may be used such as CDMA, LTE, GPRS, etc. In these examples, the access means 150 may include the technology which allows the user to access the mobile network.

In addition to this, the communication and listening device 100 may include a wireless communication means 154. The wireless communication means 154 may be useful for if the user would like to connect the communication and listening device 100 to an external electronic device such as a smartphone, a tablet, a computer, etc. The wireless communication means 154 may include short-wavelength UHF radio waves in the ISM band from 2.400 to 2.485 GHz (BLUETOOTH®) and/or WIFI.

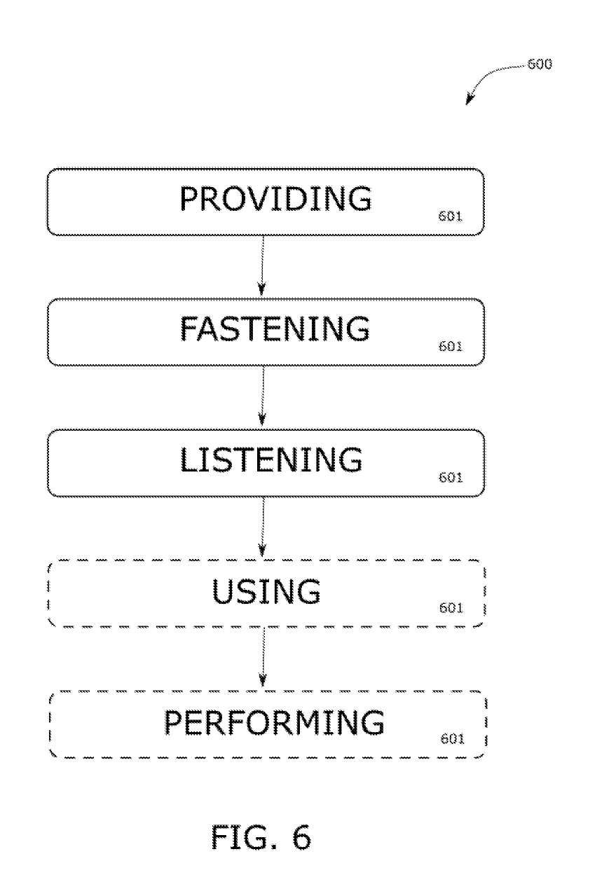

FIG. 6 is a flow diagram illustrating a method of using a communication and listening device 600, according to an embodiment of the present disclosure. As illustrated, the method of using a communication and listening device 600 may include the steps of: providing 601 the communication and listening device as above; fastening 602 the at least one ear-piece about the ear of the user via the fastening means; and listening 603 to the at least one audio file. Further steps may include: using 604 the user-interface to access the at least one mobile-network via the access means; and performing 605, at least one of: making a call, sending a text, and accessing internet.

It should be noted that steps 604 and 605 are optional steps and may not be implemented in all cases. Optional steps of method of use 600 are illustrated using dotted lines in FIG. 6 so as to distinguish them from the other steps of method of use 600. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for communication and listening device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A communication and listening device comprising:
a headset including at least one ear-piece and a fastening means for fastening the at least one ear-piece about an ear of a user, the at least one ear-piece including a first-side and a second-side;
a controller located within the headset, the controller including a microprocessor and a memory, the memory storing at least one audio file;
a display-panel located on the second-side of the at least one ear-piece and communicably coupled to the controller, the display-panel having a user-interface;
a speaker located on the first-side of the at least one ear-piece, the speaker configured to play the at least one audio file; and
an access means located within the headset, the access means configured to allow communication with at least one mobile-network.

2. The communication and listening device of claim 1, further comprising a microphone located on the headset.

3. The communication and listening device of claim 2, further comprising a voice command system configured to transform a voice communication received from the microphone and convert the voice communication into an electrical signal.

4. The communication and listening device of claim 1, further comprising a virtual assistant application.

5. The communication and listening device of claim 1, wherein the user-interface is a touchscreen.

6. The communication and listening device of claim 1, wherein the display-panel is removable.

7. The communication and listening device of claim 1, wherein the access means is a smart card.

8. The communication and listening device of claim 7, wherein the smart card is a subscriber identification module (SIM) card.

9. The communication and listening device of claim 8, wherein the headset includes a smart card slot configured to receive and interface with the identification module (SIM) card.

10. The communication and listening device of claim 1, further comprising an external storage device.

11. The communication and listening device of claim 10, wherein the headset further includes a storage device slot configured to receive and interface with the external storage device.

12. The communication and listening device of claim 1, wherein the mobile network includes a core circuit switched network configured to facilitate calls and texts.

13. The communication and listening device of claim 1, 1, wherein the mobile network further includes a packet switched network configured to facilitate mobile data.

14. The communication and listening device of claim 1, further comprising a wireless communication means.

15. The communication and listening device of claim 14, wherein the wireless communication means is short-wavelength UHF radio waves in the ISM band from 2.400 to 2.485 GHz.

16. The communication and listening device of claim 14, wherein the wireless communication means is WIFI.

17. The communication and listening device of claim 1, further comprising a global positioning means.

18. A communication and listening device comprising:
a headset including at least one ear-piece and a fastening means for fastening the at least one ear-piece about an ear of a user, the at least one ear-piece including a first-side and a second-side;
a controller located within the headset, the controller including a microprocessor and a memory, the memory storing at least one audio file;
a display-panel located on the second-side of the at least one ear-piece and communicably coupled to the controller, the display-panel having a user-interface;
a speaker located on the first-side of the at least one ear-piece, the speaker configured to play the at least one audio file;
an access means located within the headset, the access means configured to allow communication with at least one mobile-network;
a microphone located on the headset;
a voice command system configured to transform a voice communication received from the microphone, and convert the voice communication into an electrical signal;
a virtual assistant application;
an external storage device;
a wireless communication means; and
a global positioning means; and
wherein the user-interface is a touchscreen;
wherein the display-panel is removable;
wherein the access means is a smart card;
wherein the smart card is a subscriber identification module (SIM) card;
wherein the headset includes a smart card slot configured to receive and interface with the identification module (SIM) card;
wherein the headset further includes a storage device slot configured to receive and interface with the external storage device;
wherein the mobile network includes a core circuit switched network configured to facilitate calls and texts; and
wherein the mobile network further includes a packet switched network configured to facilitate mobile data.

19. A method of using a communication and listening device, the method comprising the steps of:
providing the communication and listening device including:
a headset including at least one ear-piece and a fastening means for fastening the at least one ear-piece about an ear of a user, the at least one ear-piece including a first-side and a second-side;
a controller located within the headset, the controller including a microprocessor and a memory, the memory storing at least one audio file;
a display-panel located on the second-side of the at least one ear-piece and communicably coupled to the controller, the display-panel having a user-interface;
a speaker located on the first-side of the at least one ear-piece, the speaker configured to play the at least one audio file; and
an access means located within the headset, the access means configured to allow communication with at least one mobile-network;
utilizing the user-interface to choose the at least one audio file;
fastening the at least one ear-piece about the ear of the user via the fastening means; and
listening to the at least one audio file.

20. The method of claim 19, further comprising the steps of:
using the user-interface to access the at least one mobile-network via the access means; and
performing, at least one of: making a call, sending a text, and accessing internet.
